(19) United States
(12) Patent Application Publication
(10) Pub. No.: US 2024/0101339 A1
(43) Pub. Date: Mar. 28, 2024

(54) BEVERAGE CAPSULE WITH INFUSED TEA LEAVES

(71) Applicant: Nano and Advanced Materials Institute Limited, Hong Kong (HK)

(72) Inventors: Chun Hay KO, Hong Kong (HK); Chun Fai NG, Hong Kong (HK); Ying Ying NG, Hong Kong (HK)

(21) Appl. No.: 18/466,852

(22) Filed: Sep. 14, 2023

Related U.S. Application Data
(60) Provisional application No. 63/407,156, filed on Sep. 15, 2022.

(51) Int. Cl. B65D 85/804; A23F 3/18; A23F 3/22; A23F 3/40; B65B 29/02

(52) U.S. Cl. CPC B65D 85/8043; A23F 3/18; A23F 3/22; A23F 3/405; B65B 29/022

(57) ABSTRACT

The present invention relates to an infusion product for making tea beverages, more specifically to a plant-based composition for making a tea beverage for food applications. The plants are fruits, herbs, tea and/or spices. The invention further relates to a method for producing said infusion product and its use for making a tea beverage as generated by a single-serve brewer, within a 1-minute timeframe. The invention enables users to prepare more complex tea beverages conveniently.

### CROSS-REFERENCE TO RELATED APPLICATIONS

The present application claims priority from a U.S. provisional patent application Ser. No. 63/407,156 filed Sep. 15 2022, and the disclosures of which are incorporated by reference in their entireties.

### FIELD OF THE INVENTION

The present invention relates to an infusion product for making tea beverages, more specifically to a plant-based composition for making a tea beverage for food or aromatic applications. The plants are fruits, herbs, tea and/or spices. The invention further relates to a method for producing said infusion product and its use for making a tea beverage as generated by a single-serve brewer, within a 1-minute timeframe.

### BACKGROUND

Capsule-based beverage makers have become extremely popular for rapidly producing single servings of drinks such as coffee and tea for a variety of reasons. Capsule beverage makers are user-friendly and offer a high level of convenience in that they can make a single drink serving without measuring, grinding, and other preparation steps. Capsules are designed to provide consistent results every time due to the use of pre-measured ingredients and a standardized brewing process. Further, capsule machines are compact and require minimal cleaning or other maintenance, making them highly desirable in locations such as offices. Further capsule systems offer a wide range of beverage options, from different types of coffee to teas, hot chocolates, and herbal drinks. This variety appeals to consumers with diverse tastes. However, it can be difficult to use capsule beverage systems to make more complex drinks such as various teas that are popular in Asia. For example, a cup of Hong Kong/Taiwan/Thai-style tea beverage, from tea plants (Camellia sinensis), is traditionally prepared by boiling a blend of different types of Broken Orange Pekoe (BOP), Broken Orange Pekoe Fannings (BOPF) and dust tea for around 15 to 30 minutes, and mixing the tea with parts of fruits, spices, and/or milk. For these beverages, maintaining a certain steep time is necessary for producing the best flavor. For home cooks, there is often an incomplete extraction of the tea, resulting in a highly variable and generally weak flavored beverage, or an excessive extraction, resulting in a highly variable and generally bitter taste. The highly variable flavor and taste greatly discourage consumers from attempting to prepare these beverages at home.

Alternatively, these beverages can exist in other ready-to-use forms, for example in a drip bag form, or the form of powders or granules. However, beverages made from rehydrated powders or granules are different in taste from freshly prepared ones because of the degradation of flavor content and aroma loss. Drip bag form can preserve the aroma and better imitate the flavor but the tea concentration will be insufficient and the preparation is inconvenient.

In capsule beverage systems, the infusion time for creating the beverage is quite short, typically on the order of one minute or less. Therefore, creating tea beverages in general is challenging in capsule systems. Frequently, leaf tea is mixed with instant tea in the capsule, which cannot replicate the taste of brewed teas.

U.S. Pat. No. 8,709,522 attempts to resolve this issue by forming a fabricated large leaf tea product. Because large leaf teas are considered to be a higher-quality tea, such teas are viewed as preferable with respect to flavor. However, as noted by the patent, larger-leaf teas take longer to infuse, making their use problematic. The patent defines its large leaf teas as having a leaf size greater than 16 mesh, that is, a leaf size of greater than 1.12 mm. Therefore, the '522 patent contacts the base leaf tea with a liquid tea composition for at least 5 minutes prior to drying to allow the base leaf to absorb at least some of the tea solids in the liquid tea composition into the body of the tea leaves. Thus, the resulting fabricated leaf tea has a more “closed” and “dense” structure than would be obtained by agglomerating a mixture of leaf tea and tea powder. As a result, the '522 creates a fabricated leaf tea product with 16 mesh tea leaves and a soluble tea solids content of at least 50% by weight.

However, disadvantageously, the '522 patent requires freeze drying of the tea that is to be infused into the fabricated tea leaf product and requires a very high weight content of soluble solids—that is, at least 50 percent by weight. Freeze drying is disadvantageous in that it is both expensive and may alter the taste of the resulting product. In regions with high humidity climates, tea leaves with high solids content are hygroscopic, reducing capsule shelf life as well as causing sub-optimal infusion in a capsule beverage maker.

Additionally, the '522 product only deals with fabricated tea leaves that include tea solids and does not describe techniques for including other substances in the tea leaves.

Thus, there is a need to improve infusion products for making a tea beverage, in particular, to allow for rapid extraction that is able to produce a strongly flavored beverage with a rich aroma as well as providing a more consistent beverage while avoiding variable extraction results. The present invention addresses this need.

### SUMMARY OF THE INVENTION

Addressing the above technical insufficiencies, the present invention provides a novel infusion product in the form of a single cup tea capsule. The product combines the advantage of raw tea leaves and concentrated extracts. The concentrated extracts are an excellent source of flavor, while they suffer from disadvantages including lack of aroma, difficulties to dissolve and lack of porous structure for application in single cup tea capsule. To overcome these problems, the raw tea leaves serve as a natural source of taste and aroma, and a natural porous agent for the high-pressure water flow from the single-serve brewer. The standardized, even combination of these two ingredients is achieved utilizing fluid bed or drum coating, or direct absorption of concentrated extract followed by drying. As a result, flavor-enriched tea leaves are produced.

The ingredients used in the present invention are all-natural. The hydrodynamic inside the capsule is maintained by the natural structure of the tea leaves and the granularity of the tea leaves is controlled by the coating and drying process. No excipient is used in the whole process, which differs from the current products in the market.

The invention will comprise utilizing said flavor enriched tea leave housed in a capsule for use along with a single-serve brewer—for imitating the original rich tea, spice and/or fruit flavor of the Hong Kong/Taiwan/Thai-style tea beverage compared to current products in the market, while the preparation process is inexpensive and scalable.

In one aspect, the present invention provides a capsule product for making a tea beverage in a capsule beverage maker. A capsule includes a capsule housing. Tea leaves having a size of 850 microns or less are infused with one or more infusion ingredients selected from tea, dried fruit, herbs, spices, milk, sugar, and essential oils to form infused tea leaves. A ratio of the one or more infusion ingredients to tea leaves in the infused tea leaves is from 40:60 to 5:95 (w/w). The infused tea leaves are packaged within the capsule housing.

The capsule housing includes a side wall connected to a bottom wall to form a capsule cavity and the infused tea leaves are packaged within the capsule cavity.

The capsule cavity is sealed with a pierceable cover for hot water infusion.

The one or more infusion ingredients may tea, herbs, and/or spices, and the infusion ingredients are derived from water extracts of the tea, herbs, and/or spices.

The water extracts of tea herbs, and/or spices may be selected from water extracts of Camellia sinensis, Cinnamomum cassia, Cinnamomum verum and/or Mentha balsamea Wild.

When the one or more infusion ingredients are fruit, the infusion ingredient is formed from a fruit juice. The fruit juice may be selected from one or more juices of Citrus limon, Citrus x paradisi, Citrus x sinensis, Citrus reticulate, Citrus aurantiifolia and/or Prunus persica.

The tea leaves may be selected from one or more of BOP (Broken Orange Pekoe), BOPF (Broken Orange Pekoe Fanning's) and/or tea dust of BOP and BOPF.

In a further aspect, a method of making the capsule product is provided. The method includes providing a capsule including a capsule housing and providing a plurality of tea leaves, the tea leaves having a size of 850 microns or less. The method further includes infusing the tea leaves with one or more infusion ingredients selected from the group consisting of tea, dried fruit, herbs, spices, milk, sugar, and essential oils to form infused tea leaves such that a ratio of the one or more infusion ingredients to tea leaves in the infused tea leaves is from 40:60 to 5:95 (w/w). The infused tea leaves are packaged within the capsule housing.

The infusion may be performed by applying a water extract of tea, herbs, and/or spices and/or applying a fruit juice followed by drying.

The applying may be performed by coating the water extract and/or fruit juice on the tea leaves by fluidized bed or drum coating.

Mixing the infused tea leaves into a homogeneous mixture may be further performed.

The present invention further provides a method of making a liquid tea beverage using the capsule product. The capsule product is inserted into a capsule beverage maker. A solvent under pressure of 5 to 20 bars is applied to the capsule housing having the infused tea leaves packaged therein. In one aspect, the solvent may be applied at a temperature of 75 to 100° C. The solvent may be water, milk, or mixtures thereof.

### BRIEF DESCRIPTION OF THE DRAWINGS

FIG. 1 shows a diagram of a container (single-cup capsule) of the present invention. (101: filter paper and/or aluminum foil; 102: coated/infused tea leaves; 103: plastic or metal or its alloy)

FIG. 2 shows the tea-infused tea leaves using absorption approach (right) and milk tea-infused tea leaves using coating approach (left).

FIG. 3 shows the wetted milk tea extract forms aggregate and blocks the water flow inside the capsule.

### DETAILED DESCRIPTION

The present invention relates to a capsule product and a method for making a tea beverage using a capsule beverage maker. The capsule product is designed to enhance the convenience and efficiency of preparing tea beverages with a precise combination of infusion products. The capsule contains tea leaves that have been carefully infused with various infusion ingredients, and the method involves the use of a capsule beverage maker to produce a liquid tea beverage.

Capsule Product Composition:

The capsule product comprises a capsule housing a plurality of tea leaves, which are infused with one or more infusion ingredients. The tea leaves used in this invention have a size of 850 microns or less, ensuring optimal extraction during the brewing process. The infusion ingredients may include tea, dried fruit, herbs, spices, milk, sugar, and essential oils, among others. The ratio of the infusion ingredients to tea leaves within the infused tea leaves ranges from 40:60 to 5:95 (w/w). This specific composition ensures a harmonious blend of flavors and aromas in the final tea beverage while enabling the rapid beverage creation that is required in capsule beverage makers without ingredient clumping that prevents adequate solvent circulation. The infused tea leaves are packaged within the capsule housing, preserving the freshness and quality of the ingredients.

Capsule Housing Structure:

The capsules used in the present invention are containers in which the tea material may be packaged, for example a cylindrical capsule, cartridge, pod, or the like. Single use capsules or refillable capsules may be used. Further, various capsule designs may be configured to conform to various commercial beverage makers.

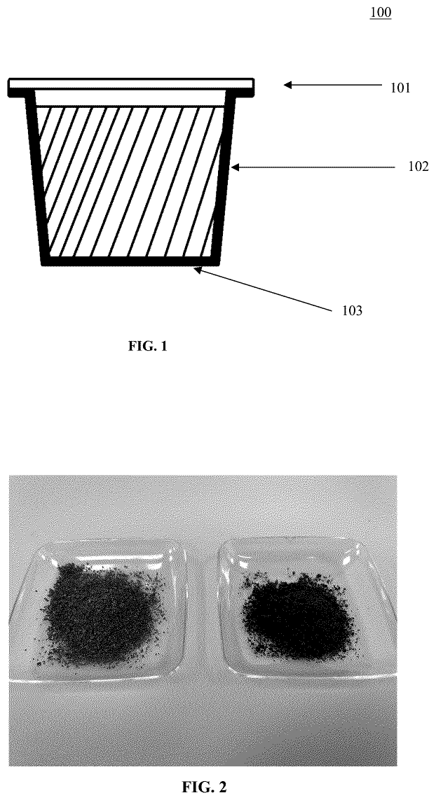

As seen in FIG. 1, the capsule includes a side wall 102 and a bottom wall 103, which together form a capsule cavity. The infused tea leaves are contained within this capsule cavity. To facilitate the brewing process, the capsule cavity is sealed with a pierceable cover 101, allowing hot water to enter and interact with the infused tea leaves to brew the final beverage. Typically, the capsule cavity is a polymer such as polyethylene, while the pierceable cover is a metal foil or laminate that is adhesively bonded to the capsule cavity.

Infusion Process:

The infusion ingredients are carefully selected based on the desired flavor profile. In the case of using tea, herbs, and/or spices, water extracts of these ingredients are employed. The water extracts are derived from sources such as Camellia sinensis, Cinnamomum cassia, Cinnamomum verum, and Mentha balsamea Wild. For fruit-based infusion ingredients, fruit juices are utilized. Fruit juices from sources such as Citrus limon, Citrus x paradisi, Citrus x sinensis, Citrus reticulate, Citrus aurantiifolia, and Prunus persica contribute to a vibrant flavor. Because the ingredients are infused into the tea leaves themselves, there is no material that needs to be packaged into the capsule other than the infused tea leaves themselves, simplifying the overall packaging process.

Method of Preparation:

The invention also encompasses a method for making the capsule product. The method involves providing a capsule housing, infusing the tea leaves with the selected infusion ingredients, and packaging the resulting infused tea leaves within the capsule housing. The infusion process may include applying water extracts or fruit juice to the tea leaves, followed by drying to form the infused tea leaves. Techniques such as fluidized bed or drum coating can be employed to ensure a uniform coating of the infusion ingredients on the tea leaves. Mixing the infused tea leaves into a homogeneous mixture further enhances the consistency of the final product.

Tea Leaves

As used herein, the term “tea leaves” refers to tea plant material such as a variety of the Camellia sinensis tea plant. Although the term “leaves” is used throughout the specification, the tea leaves may also include bud or stem materials.

Various types of tea leaves may be used in the present invention, that vary based on their processing. All the processed tea leaves may be used in the products and processes of the present invention.

Tea is made from the leaves of the Camellia sinensis plant. There are two main Camellia sinensis: Camellia sinensis sinensis, cultivated in China, has small leaves and can withstand cold weather. Camellia sinensis assamica originated in India and is cultivated in more tropical regions and has a larger leaf. There are many varieties of tea plants within these two categories. The various types of tea are created using different processing techniques that create different amounts of oxidation: black tea, green tea, oolong tea, and white tea.

Black Tea: Black tea has a dark hue and a strong flavor since it has fully oxidized. The leaves are dried after being wilted, rolled, and given time to fully oxidize. Black tea gets its distinctive dark color, strong flavor, and increased caffeine content from this method compared to other tea varieties. Black teas with a following include Assam, Darjeeling, Ceylon, and Earl Grey.

Green Tea: Green tea is minimally oxidized. The tea leaves are rapidly heated after they have withered (often by steaming or pan-firing) to stop oxidation and maintain their green color and inherent antioxidants. Compared to black tea, green tea has a softer flavor and typically contains less caffeine. Sencha, Matcha, Gunpowder, Jasmine, and Dragonwell are types of green tea. Yellow tea is a type of tea produced similarly to green tea but with an additional step of allowing the leaves to yellow slightly during processing. Huang Shan Mao Feng and Junshan Yinzhen are examples of yellow tea.

Oolong Tea: Oolong tea is partially oxidized. The leaves are withered, rolled, and allowed to oxidize to varying degrees, resulting in a range of flavors and aromas. Oolong tea can have characteristics of both black and green tea, resulting in a diverse flavor profile. Tie Guan Yin, Wuyi Rock Oolong, and Oriental Beauty are examples of oolong teas.

White tea: White tea undergoes minimal oxidation and processing and uses young leaves and buds that are simply withered and dried. This delicate processing retains the natural appearance and subtle flavors of the tea leaves. White tea has a light and subtle flavor profile with lower caffeine content. Silver Needle and Bai Mu Dan are well-known white tea varieties.

Beverage Preparation:

To create a liquid tea beverage, the capsule product is inserted into a capsule beverage maker. A solvent, which can be water, milk, or a mixture thereof, is applied under pressure (5 to 20 bars) to the capsule housing containing the infused tea leaves. This process effectively extracts the flavors and aromas from the infused tea leaves. The solvent is typically applied at a temperature ranging from 75 to 100° C., promoting optimal extraction without compromising the delicate characteristics of the ingredients.

In conclusion, the present invention introduces a capsule product and method that revolutionizes the preparation of tea beverages. By combining carefully infused tea leaves and a specialized capsule beverage maker, this innovation offers a convenient and efficient way to enjoy a wide range of flavorful and aromatic tea beverages, particularly those with strong and unique tea flavors that cannot be produced with current capsule products.

The following examples demonstrate the methods of making the capsule products with infused tea leaves according to the present invention as well as techniques for brewing specialized Asian teas with unique and strong flavors.

### EXAMPLES

### Example 1

Preparation of Hong Kong-Style Milk Tea with Tea-Infused Tea Leaves Using Absorption Approach.

200 grams of blended tea leaves were prepared by mixing the DUST Ceylon tea, BOPF Ceylon tea and BOP Ceylon tea in a ratio of 60:35:30. 100 grams of the blended tea leaves were extracted with 2000 mL of water at 100° C. for 15 minutes. The tea extract was filtered with a cotton tea filter bag. The residue was pressed to collect all tea extract. The tea extract was concentrated to less than 250 mL by continuous boiling at 100° C.

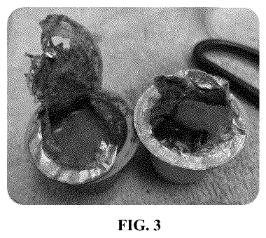

The remaining 100 grams of the blended tea leaves was added to the concentrated tea extract to absorb the liquid. The tea-infused tea leaves were mixed until no liquid was left. The tea-infused tea leaves were dried by fluid bed dryer Solidlab 1 (Hüttlin GmbH, Germany) at 70° C. for 90 minutes. The dried tea leaves were screened using a 20 mesh sieve, and the dried tea leaves passing through the sieve were collected (FIG. 2).

The prototype of infusion product for milk tea was fabricated by adding 3.2 g of dried tea leaves into the container (capsule). 90 mL of concentrated tea was prepared from the capsule using coffee capsule machine, such as CMC-111 (German Pool Group Ltd, Hong Kong). 36 mL of evaporated milk was added to the concentrated tea to prepare the Hong Kong-style milk tea beverage. A pleasant and smooth milk-flavored tea beverage with natural aroma was resulted.

### Example 2

Preparation of Hong Kong-Style Lemon Tea with Lemon-Infused Tea Leaves Using Coating Approach.

200 grams of blended tea leaves were prepared by mixing the DUST Ceylon tea, BOPF Ceylon tea and BOP Ceylon tea in a ratio of 60:35:30. The tea leaves were heated to 70° C. by fluid bed system Solidlab 1 (Hüttlin GmbH, Germany). 240 grams of fresh lemon juice (estimated solid content: 20.23 grams) was heated to 80° C. and 67 grams of white sugar was added. The sweetened lemon juice was coated to the tea leaves in the fluid bed system with the conditions of spray air pressure of 0.3 bar, microcl./spray width of 150 mbar and liquid flow ratio of 2.1 g/min. The dried tea leaves were screened using a 20 mesh sieve, and the dried tea leaves passing through the sieve were collected. 2 mL of lemon essential oil was added to the dried tea leaves and mixed.

Prototype of infusion product for lemon tea was fabricated by adding 4 grams of dried tea leaves into the container (coffee capsule). 120 mL of Hong Kong-style lemon tea beverage was prepared from the capsule using coffee capsule machine, such as CMC-111 (German Pool Group Ltd, Hong Kong). Tea brewed from the prototype of the infusion product produced a palatable beverage having an attractive lemon flavor and aroma.

### Example 3

Preparation of Hong Kong-Style Milk Tea with Milk Tea-Infused Tea Leaves Using Coating Approach.

400 grams of blended tea leaves were prepared by mixing the DUST Ceylon tea, BOPF Ceylon tea and BOP Ceylon tea in a ratio of 60:35:30. 200 grams of the blended tea leaves were blended by a blender (Blendtec CHEF 600) with 2000 mL of evaporated milk for 2 minutes in 2 batches. The milk tea extract was filtered with cotton tea filter bag. The residue was pressed to collect all tea extract. The milk tea extract was concentrated to less than 250 mL by continuous boiling at 100° C.

The tea leaves were heated to 70° C. by fluid bed system Solidlab 1 (Hüttlin GmbH, Germany). 240 grams of milk tea extract was heated to 80° C. The milk tea extract was coated to the tea leaves in the fluid bed system with the conditions of spray air pressure of 0.5 bar, microcl./spray width of 250 mbar and liquid flow ratio of 2.1 g/min. The dried tea leaves were screened using a 20 mesh sieve, and the dried tea leaves passing through the sieve were collected (FIG. 2).

Prototype of infusion product for lemon tea was fabricated by adding 8 grams of dried tea leaves into the container (coffee capsule). 120 mL of Hong Kong-style milk tea beverage was prepared from the capsule using coffee capsule machine, such as CMC-111 (German Pool Group Ltd, Hong Kong).

### Example 4

Preparation of Thai-Style Milk Tea with Tea-Infused Tea Leaves Using Absorption Approach.

100 grams of the pre-mixed blended Thai tea leaves were extracted with 1000 mL of water at 100° C. for 10 minutes. The tea extract was filtered with cotton tea filter bag. The residue was pressed to collect all tea extract. The tea extract was concentrated to less than 250 mL by continuous boiling at 100° C.

The remaining 100 grams of the blended tea leaves was added to the concentrated tea extract to absorb the liquid. The tea-infused tea leaves were mixed until no liquid was left. The tea-infused tea leaves were dried by convection oven at 140° C. for 8 hours. The dried tea leaves were milled using a coffee mill R-220 (Fuji Kouki Co., Ltd., Japan) at fineness setting of 6.

Prototype of infusion product for milk tea was fabricated by adding 4 g of dried tea leaves into the container (capsule). 120 mL of concentrated tea was prepared from the capsule using coffee capsule machine, such as CMC-111 (German Pool Group Ltd, Hong Kong). 10 mL of evaporated milk and 7.5 mL of condensed milk were added to the concentrated tea to prepare the Thai-style milk tea beverage.

### Example 5

Preparation of Hong Kong-Style Milk Tea with Tea-Infused Tea Leaves Using Absorption Approach with Freeze Drying.

205 grams of blended tea leaves were prepared by mixing the DUST Ceylon tea, BOPF Ceylon tea and BOP Ceylon tea in a ratio of 60:35:30. 135 grams of the blended tea leaves were extracted with 1200 mL water at 100° C. for 15 minutes. The tea extract was filtered with cotton tea filter bag. The residue was pressed to collect all tea extract. The resulting tea extract has a volume of 900 mL. 50 mL of the tea extract was freeze dried to quantify the solid content, which is 1.69 grams. The remaining 850 mL tea extract was concentrated to 85 mL by rotary evaporation at 60° C., 72 mbar vacuum for 2 hours.

The concentrated tea extract (estimated solid content: 28.73 grams) was added to 70 grams of blended tea leaves and mixed with a drum mixer. The blended tea leaves with absorbed tea extract was dried convection. The dried tea leaves were screened using a 20 mesh sieve, and the dried tea leaves passing through the sieve were collected.

The prototype of infusion product for milk tea was fabricated by adding 3.5 g of dried tea leaves into the container (capsule). 90 mL of concentrated tea was prepared from the capsule using coffee capsule machine, such as Lattissima One (Nespresso S.A.). 30 mL of evaporated milk was added to the concentrated tea to prepare the Hong Kong-style milk tea beverage. A pleasant and smooth milk-flavored tea beverage with natural aroma was resulted.

### Comparative Example 1

Preparation of Hong Kong-Style Milk Tea with Tea Leaves without Tea-Infusion.

200 grams of blended tea leaves were prepared by mixing the DUST Ceylon tea, BOPF Ceylon tea and BOP Ceylon tea in a ratio of 60:35:30.

Prototype of non-infusion product for milk tea was fabricated by adding 3.2 g of blended tea leaves into the container (capsule). 90 mL of concentrated tea was prepared from the capsule using coffee capsule machine, such as CMC-111 (German Pool Group Ltd, Hong Kong). Tea brewed from prototype of the non-infusion product resulted in an insufficiently concentrated tea. 36 mL of evaporated milk was added to the concentrated tea to prepare the Hong Kong-style milk tea beverage. The taste and aroma of tea and milk were compared with Examples 1 and 3. The result is shown in Table 1.

### Comparative Example 2

Preparation of Hong Kong-Style Milk Tea with Traditional Method.

125 grams of blended tea leaves were prepared by mixing the DUST Ceylon tea, BOPF Ceylon tea and BOP Ceylon tea in a ratio of 60:35:30. The blended tea leaves were added into a cotton tea filter bag and extracted with 2000 mL of water at 100° C. for 15 minutes. The blended tea leaves was washed with the tea extract for 4 times. The blended tea leaves were further extracted at 100° C. for 5 minutes. All tea extract was collected. 600 mL of evaporated milk was added to the tea extract to produce traditional style Hong Kong-style milk tea. The taste and aroma of tea and milk were compared with Example 1 and 3. The result is shown in Table 1.

TABLE 1

| Example | Flavor (Tea) | Aroma (Tea) | Flavor (Milk) |
|---|---|---|---|
| Example 1 | Present | Present | Present |
| Example 3 | Weakened | Weakened | Weakened |
| Comparative | Masked | Present | Present |
| Example 1 | by milk | | |
| Comparative | Present | Present | Present |
| Example 2 | | | |

### Comparative Example 3

Preparation of Hong Kong-Style Milk Tea with Milk Tea Extract in the Capsule.

125 grams of blended tea leaves were prepared by mixing the DUST Ceylon tea, BOPF Ceylon tea and BOP Ceylon tea in a ratio of 60:35:30. The blended tea leaves were extracted with 2000 mL of water at 100° C. for 15 minutes. The tea extract was filtered with cotton tea filter bag. The residue was pressed to collect all tea extract. 600 mL of evaporated milk was added to the tea extract to produce milk tea extract.

The milk tea extract was freeze dried with laboratory freeze dryer FreeZone 2.5 Liter (Labconco Corporation, US). The freeze dried milk tea extract was milled to fine powder with Tube Mill control (IKA, Germany).

Prototype of extract product for milk tea was fabricated by adding 4 grams of freeze dried milk tea extract into the container (capsule). Only 20 mL of Hong Kong-style milk tea beverage was prepared from the capsule using capsule machine, such as CMC-111 (German Pool Group Ltd, Hong Kong) due to blockage inside the capsule. Aggregate was found inside the used capsule, which further confirmed the ineffective flow of water (FIG. 3).

### Comparative Example 4

Preparation of Hong Kong-Style Lemon Tea with Lemon Flavoring in the Coffee Capsule.

200 grams of blended tea leaves were prepared by mixing the DUST Ceylon tea, BOPF Ceylon tea and BOP Ceylon tea in a ratio of 60:35:30.

Prototype of infusion product for lemon tea was fabricated by adding 3.6 grams of blended tea leaves and 0.4 grams of lemon flavoring into the container (coffee capsule). 120 mL of Hong Kong-style lemon tea beverage was prepared from the capsule using coffee capsule machine, such as CMC-111 (German Pool Group Ltd, Hong Kong). The taste and aroma of tea and lemon were compared with Example 2. The result is shown in Table 2.

TABLE 2

| | Flavor | Aroma | Citrus Flavor | Sourness | Aroma |
|---|---|---|---|---|---|
| Example | (Tea) | (Tea) | (Lemon) | (Lemon) | (Lemon) |
| Example 2 | Present | Present | Present | Present | Present |
| Comparative | Present | Present | Weakened | Present | Absent |
| Example 4 | | | | | |

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints. Unless otherwise specified, all the ranges disclosed in the present disclosure include endpoints. The term “substantially coplanar” may refer to two surfaces within a few micrometers (μm) positioned along the same plane, for example, within 10 μm, within 5 μm, within 1 μm, or within 0.5 μm located along the same plane. When reference is made to “substantially” the same numerical value or characteristic, the term may refer to a value within ±10%, ±5%, ±1%, or ±0.5% of the average of the values.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed:

1. A capsule product for making a tea beverage in a capsule beverage maker, comprising:
a capsule including a capsule housing;
a plurality of tea leaves, the tea leaves having a size of 850 microns or less, the tea leaves being infused with one or more infusion ingredients selected from the group consisting of tea, dried fruit, herbs, spices milk, sugar, and essential oils to form infused tea leaves;
wherein a ratio of the one or more infusion ingredients to tea leaves in the infused tea leaves is from 40:60 to 5:95 (w/w); and
wherein the infused tea leaves are packaged within the capsule housing.

2. The capsule product of claim 1, wherein the capsule housing includes a side wall connected to a bottom wall to form a capsule cavity and the infused tea leaves are packaged within the capsule cavity.

3. The capsule product of claim 1, wherein the capsule cavity is sealed with a pierceable cover for hot water infusion.

4. The capsule product of claim 1, wherein when the one or more infusion ingredients are tea, herbs, and/or spices, the infusion ingredients are derived from water extracts of the tea, herbs, and/or spices.

5. The capsule product of claim 3, wherein the water extracts of tea herbs, and/or spices are selected from water extracts of Camellia sinensis, Cinnamomum cassia, Cinnamomum verum and/or Mentha balsamea Wild.

6. The capsule product of claim 1, wherein when the one or more infusion ingredients are fruit, the infusion ingredients is in form of a fruit juice.

7. The capsule product of claim 6, wherein the fruit juice is selected from one or more juices of Citrus limon, Citrus x paradisi, Citrus x sinensis, Citrus reticulate, Citrus aurantiifolia and/or Prunus persica.

8. The capsule product of claim 1, wherein the tea leaves are selected from one or more of BOP (Broken Orange Pekoe), BOPF (Broken Orange Pekoe Fanning's) and/or tea dust of BOP and BOPF.

9. A method of making the capsule product of claim 1, comprising:
providing a capsule including a capsule housing;
providing a plurality of tea leaves, the tea leaves having a size of 850 microns or less;
infusing the tea leaves with one or more infusion ingredients selected from the group consisting of tea, dried fruit, herbs, spices milk, sugar, and essential oils to form infused tea leaves such that a ratio of the one or more infusion ingredients to tea leaves in the infused tea leaves is from 40:60 to 5:95 (w/w); and
packaging the infused tea leaves within the capsule housing.

10. The method of claim 9, wherein the infusion is performed by applying a water extract of tea, herbs, and/or spices and/or applying a fruit juice followed by drying.

11. The method of claim 10, wherein the applying is performed by coating the water extract and/or fruit juice on the tea leaves or absorbing the water extract and/or fruit juice into the leaves by fluidized bed or drum coating.

12. The method of claim 9, further comprising mixing the infused tea leaves into a homogeneous mixture.

13. A method of making a liquid tea beverage comprising:
inserting the capsule product of claim 1 into a capsule beverage maker; and
applying a solvent under pressure of 5 to 20 bars to the capsule housing having the infused tea leaves packaged therein.

14. The method of making the liquid tea beverage of claim 13, where the solvent is applied at a temperature of 75 to 100° C.

15. The method of making the liquid tea beverage of claim 13, wherein the solvent is selected from water, milk, and mixtures thereof.
